(19) United States
(12) Patent Application Publication
(10) Pub. No.: US 2022/0271314 A1
(43) Pub. Date: Aug. 25, 2022

(54) FUEL CELL

(71) Applicant: TOYOTA JIDOSHA KABUSHIKI KAISHA, Toyota-shi (JP)

(72) Inventor: Akito KAWASUMI, Toyota-shi (JP)

(21) Appl. No.: 17/651,863

(22) Filed: Feb. 21, 2022

(30) Foreign Application Priority Data
Feb. 24, 2021 (JP) 2021-027265

(51) Int. Cl. H01M 8/1004

(52) U.S. Cl. CPC H01M 8/1004

(57) ABSTRACT

To provide a fuel cell configured to suppress chemical deterioration of an electrolyte membrane. A fuel cell wherein each of the first gas diffusion layer, the first catalyst layer and the electrolyte membrane includes a peripheral portion which is a region not facing the second catalyst layer, and a central portion which is a region being surrounded by the peripheral portion and facing the second catalyst layer; wherein the peripheral portion of the electrolyte membrane includes an adhesive layer on a second catalyst layer-side surface; wherein the electrolyte membrane is attached to the resin frame via the adhesive layer; wherein the first gas diffusion layer contains a peroxide decomposition catalyst; and wherein the peripheral portion of the first gas diffusion layer includes a hydrophilic layer on a first catalyst layer-side surface.

The disclosure relates to a fuel cell.

### BACKGROUND

A fuel cell (FC) is a power generation device that generates electrical energy by electrochemical reaction between fuel gas (e.g., hydrogen) and oxidant gas (e.g., oxygen) in a single unit fuel cell or a fuel cell stack (hereinafter, it may be simply referred to as “stack”) composed of stacked unit fuel cells (hereinafter may be referred to as “cell”). In many cases, the fuel gas and oxidant gas actually supplied to the fuel cell are mixtures with gases that do not contribute to oxidation and reduction. Especially, the oxidant gas is often air containing oxygen.

Hereinafter, fuel gas and oxidant gas may be collectively and simply referred to as “reaction gas” or “gas”. Also, a single unit fuel cell and, a fuel cell stack composed of stacked unit fuel cells may be collectively referred to as “fuel cell”.

In general, the unit fuel cell includes a membrane electrode assembly (MEA).

The membrane electrode assembly has a structure such that a catalyst layer and a gas diffusion layer (or GDL, hereinafter it may be simply referred to as “diffusion layer”) are sequentially formed on both surfaces of a solid polymer electrolyte membrane (hereinafter, it may be simply referred to as “electrolyte membrane”). Accordingly, the membrane electrode assembly may be referred to as “membrane electrode gas diffusion layer assembly” (MEGA).

As needed, the unit fuel cell includes two separators sandwiching both sides of the membrane electrode gas diffusion layer assembly. In general, the separator has a structure such that a groove is formed as a reaction gas flow path on a surface in contact with the gas diffusion layer. The separator has electronic conductivity, and it functions as a collector of generated electricity.

In the fuel electrode (anode) of the fuel cell, hydrogen (H 2) as the fuel gas supplied from the gas flow path and the gas diffusing layer, is protonated by the catalytic action of the catalyst layer, and the protonated hydrogen goes to the oxidant electrode (cathode) through the electrolyte membrane. An electron is generated at the same time, and it passes through an external circuit, does work, and then goes to the cathode. Oxygen (O₂) as the oxidant gas supplied to the cathode, reacts with protons and electrons in the catalyst layer of the cathode, thereby generating water. The generated water gives appropriate humidity to the electrolyte membrane, and excess water penetrates the gas diffusion layer and then is discharged to the outside of the system.

Various researches have been conducted on fuel cells configured to be installed and used in fuel cell electric vehicles (hereinafter may be referred to as “vehicle”).

For example, Patent Literature 1 discloses a fuel cell in which a resin frame or film and the outer periphery of an electrolyte membrane/electrode structure are bonded via an adhesive containing a quencher.

Patent Literature 2 discloses a fuel cell capable of preventing more certainly deterioration of an electrolyte membrane due to hydrogen peroxide radicals.

Patent Literature 3 discloses a fuel cell suppressing local deterioration of an electrolyte membrane and deterioration of the end portion of a catalyst layer and lengthening the life of the fuel cell by reducing the stay of generated water containing hydrogen peroxide or hydroxide radicals between the catalyst layer and a resin film surrounding the catalyst layer.
Patent Literature 1: Japanese Patent Application Laid-Open (JP-A) No. 2015-035357
Patent Literature 2: JP-A No. 2008-218100
Patent Literature 3: JP-A No. 2010-067371

A fuel cell has a problem in that the electrolyte membrane is deteriorated when the operation (power generation) is continued. It is thought that this deterioration is due to the attack on the electrolyte membrane by hydrogen peroxide or hydroxy radicals, each of which is a by-product that is inevitably produced when an electrode reaction occurs at the cathode and the anode. To avoid this problem, it is widely practiced to use a cerium compound as a quencher that is capable of decomposing hydrogen peroxide or hydroxy radicals and add the cerium compound to the electrolyte membrane. However, the cerium compound reduces ion conduction, and it is desirable not to add the cerium compound to the electrolyte membrane or the catalyst layer as much as possible.

The peripheral portion of the cathode catalyst layer is a portion where the electrolyte membrane is exposed and the oxidant gas easily touches the electrolyte membrane directly, and the electrolyte membrane at that portion tends to be more deteriorated as compared with the electrolyte membrane near the central portion. Accordingly, the amount of the added cerium compound needs to be large. As described above, the cerium compound reduces ion conduction, and it is possible to incorporate the cerium compound into the peripheral portion of the electrolyte membrane and the peripheral portion of the catalyst layer in contact with the electrolyte membrane, as long as the deterioration of the peripheral portion of the electrolyte membrane is suppressed. However, since the electrolyte membrane and the catalyst layer are each formed from a precursor paste, it is difficult to increase the cerium compound concentration of only the peripheral portion, and the concentration of the whole tends to be high. In Patent Literature 1, accordingly, the cerium compound is contained in the adhesive used at the peripheral portion.

The adhesive layer of Patent Literature 1 is formed by applying an adhesive paste. An adhesive paste generally has high viscosity. Accordingly, when applied, bubbles are easily formed in the applied adhesive, and a crack is easily formed in the adhesive layer thus produced. When the source of cerium to the electrolyte membrane is the adhesive layer having the crack, there is a possibility that the deterioration of the electrolyte membrane facing the crack is not be suppressed.

### SUMMARY

In view of the above circumstances, an object of the disclosed embodiments is to provide a fuel cell configured to suppress chemical deterioration of an electrolyte membrane.

### Means for Solving the Problems

In a first embodiment, there is provided a fuel cell comprising a membrane electrode gas diffusion layer assembly, a resin frame, a first separator and a second separator,

wherein the membrane electrode gas diffusion layer assembly includes a first gas diffusion layer, a first catalyst layer, an electrolyte membrane, a second catalyst layer, and a second gas diffusion layer in this order;

wherein the resin frame is disposed on an outer periphery of the membrane electrode gas diffusion layer assembly and is disposed between the first separator and the second separator;

wherein each of the first gas diffusion layer, the first catalyst layer and the electrolyte membrane includes a peripheral portion which is a region not facing the second catalyst layer, and a central portion which is a region being surrounded by the peripheral portion and facing the second catalyst layer;

wherein the peripheral portion of the electrolyte membrane includes an adhesive layer on a second catalyst layer-side surface;

wherein the electrolyte membrane is attached to the resin frame via the adhesive layer;

wherein the first gas diffusion layer contains a peroxide decomposition catalyst; and

wherein the peripheral portion of the first gas diffusion layer includes a hydrophilic layer on a first catalyst layer-side surface.

The central portion of the first gas diffusion layer may include a water repellent layer on a first catalyst layer-side surface.

The first separator may be an anode-side separator.

The first gas diffusion layer may be an anode-side gas diffusion layer.

The first catalyst layer may be an anode catalyst layer.

The second separator may be a cathode-side separator.

The second gas diffusion layer may be a cathode-side gas diffusion layer.

The second catalyst layer may be a cathode catalyst layer.

According to the fuel cell of the disclosed embodiments, dissolution of the peroxide decomposition catalyst from the gas diffusion layer in the electrolyte membrane can be accelerated, and chemical deterioration of the electrolyte membrane can be suppressed.

### BRIEF DESCRIPTION OF THE DRAWINGS

In the accompanying drawings,

FIG. 1 is a schematic cross-sectional view of an example of the fuel cell of the disclosed embodiments, and

FIG. 2 is a diagram for explaining a mechanism for suppressing deterioration of the electrolyte membrane of the fuel cell according to the disclosed embodiments.

### DETAILED DESCRIPTION

The fuel cell of the disclosed embodiment is a fuel cell comprising a membrane electrode gas diffusion layer assembly, a resin frame, a first separator and a second separator,

wherein the membrane electrode gas diffusion layer assembly includes a first gas diffusion layer, a first catalyst layer, an electrolyte membrane, a second catalyst layer, and a second gas diffusion layer in this order;

wherein the resin frame is disposed on an outer periphery of the membrane electrode gas diffusion layer assembly and is disposed between the first separator and the second separator;

wherein each of the first gas diffusion layer, the first catalyst layer and the electrolyte membrane includes a peripheral portion which is a region not facing the second catalyst layer, and a central portion which is a region being surrounded by the peripheral portion and facing the second catalyst layer;

wherein the peripheral portion of the electrolyte membrane includes an adhesive layer on a second catalyst layer-side surface;

wherein the electrolyte membrane is attached to the resin frame via the adhesive layer;

wherein the first gas diffusion layer contains a peroxide decomposition catalyst; and

wherein the peripheral portion of the first gas diffusion layer includes a hydrophilic layer on a first catalyst layer-side surface.

According to the fuel cell of the disclosed embodiments, the peroxide decomposition catalyst such as a cerium compound is added to the gas diffusion layer, and the portion to which the peroxide decomposition catalyst is added is hydrophilized, so that the peroxide decomposition catalyst compound can be easily diffused from the gas diffusion layer into the electrolyte membrane.

In the disclosed embodiments, by hydrophilizing the peripheral portion of the gas diffusion layer containing the peroxide decomposition catalyst, chemical deterioration of the membrane in the vicinity of the crack of the adhesive layer can be suppressed, and the life of the fuel cell can be enhanced. In the disclosed embodiments, deterioration of the catalyst layer can be suppressed by incorporating the peroxide decomposition catalyst into the gas diffusion layer, instead of incorporating the peroxide decomposition catalyst into the catalyst layer.

The fuel cell may be a fuel cell composed of only one unit fuel cell, or it may be a fuel cell stack composed of stacked unit fuel cells.

The number of the stacked unit fuel cells is not particularly limited. For example, 2 to several hundred unit fuel cells may be stacked, or 2 to 200 unit fuel cells may be stacked.

The fuel cell stack may include an end plate at both stacking direction ends of each unit fuel cell.

Each unit fuel cell includes at least the membrane electrode gas diffusion layer assembly, the resin frame, the first separator and the second separator.

The membrane electrode gas diffusion layer assembly includes the first gas diffusion layer, the first catalyst layer, the electrolyte membrane, the second catalyst layer and the second gas diffusion layer in this order.

More specifically, the membrane electrode gas diffusion layer assembly includes the anode-side gas diffusion layer, the anode catalyst layer, the electrolyte membrane, the cathode catalyst layer and the cathode-side gas diffusion layer in this order.

Each of the first gas diffusion layer, the first catalyst layer and the electrolyte membrane includes the peripheral portion which is the region not facing the second catalyst layer, and the central portion which is the region being surrounded by the peripheral portion and facing the second catalyst layer.

Accordingly, each of the first gas diffusion layer, the first catalyst layer and the electrolyte membrane has a larger area in the plane direction than the second catalyst layer. When the membrane electrode gas diffusion layer assembly is viewed from above, the second catalyst layer is disposed more inside than the outer periphery of the first gas diffusion layer, that of the first catalyst layer, and that of the electrolyte membrane. The size of the second gas diffusion layer in the plane direction is not particularly limited. The peripheral portion of the first gas diffusion layer, that of the first catalyst layer, and that of the electrolyte membrane may face the second gas diffusion layer. The area of the second gas diffusion layer in the plane direction may be the same as the area of the second catalyst layer in the plane direction. When the membrane electrode gas diffusion layer assembly is viewed from above, the second gas diffusion layer may be disposed at the same position as the second catalyst layer.

One of the first and second catalyst layers is the cathode catalyst layer, and the other is the anode catalyst layer.

The cathode (oxidant electrode) includes the cathode catalyst layer and the cathode-side gas diffusion layer.

The anode (fuel electrode) includes the anode catalyst layer and the anode-side gas diffusion layer.

The first catalyst layer and the second catalyst layer are collectively referred to as “catalyst layer”. The cathode catalyst layer and the anode catalyst layer are collectively referred to as “catalyst layer”.

The catalyst layer may contain a catalyst metal for accelerating an electrochemical reaction, a proton-conducting electrolyte, and an electron-conducting carrier, for example.

As the catalyst metal, for example, platinum (Pt) or an alloy of Pt and another metal (such as Pt alloy mixed with cobalt, nickel or the like) may be used.

The electrolyte may be fluorine resin or the like. As the fluorine resin, for example, a Nafion solution may be used.

The catalyst metal is supported on the carrier. In each catalyst layer, the carrier supporting the catalyst metal (i.e., catalyst supporting carrier) and the electrolyte may be mixed.

As the carrier for supporting the catalyst metal, examples include, but are not limited to, a commercially-available carbon material such as carbon.

One of the first gas diffusion layer and the second gas diffusion layer is the cathode-side gas diffusion layer, and the other is the anode-side gas diffusion layer.

The first gas diffusion layer is the cathode-side gas diffusion layer when the first catalyst layer is the cathode catalyst layer. The first gas diffusion layer is the anode-side gas diffusion layer when the first catalyst layer is the anode catalyst layer.

The second gas diffusion layer is the cathode-side gas diffusion layer when the second catalyst layer is the cathode catalyst layer. The second gas diffusion layer is the anode-side gas diffusion layer when the second catalyst layer is the anode catalyst layer.

The first gas diffusion layer and the second gas diffusion layer are collectively referred to as “gas diffusion layer” or “diffusion layer”. The cathode-side gas diffusion layer and the anode-side gas diffusion layer are collectively referred to as “gas diffusion layer” or “diffusion layer”.

The gas diffusion layer may be a gas-permeable electroconductive member or the like.

As the electroconductive member, examples include, but are not limited to, a porous carbon material such as carbon cloth and carbon paper, and a porous metal material such as metal mesh and foam metal.

The first gas diffusion layer contains a peroxide decomposition catalyst. The second gas diffusion layer may contain a peroxide decomposition catalyst or may be free of a peroxide decomposition catalyst. In general, the thickness of the anode catalyst layer is smaller than that of the cathode catalyst layer. Accordingly, the peroxide decomposition catalyst contained in the anode-side gas diffusion layer dissolves in the electrolyte membrane faster than the peroxide decomposition catalyst contained in the cathode-side gas diffusion layer, and the peroxide decomposition catalyst quickly reaches the electrolyte membrane. Accordingly, the first gas diffusion layer may be the anode-side gas diffusion layer; the first catalyst layer may be the anode catalyst layer; and the first separator may be the anode-side separator.

The peroxide decomposition catalyst is not particularly limited, as long as it is a substance that can decompose at least any of hydrogen peroxide and hydroxy radicals. As the peroxide decomposition catalyst, examples include, but are not limited to, a metal, a metal oxide, a metal fluoride, a metal phosphate and a macrocyclic metal complex. As the metal, examples include, but are not limited to, Ru, Ag, Ce and Mn. As of the metal oxide, examples include, but are not limited to, RuO₂, WO₃, CeO₂, MnO₂ and Fe₃O₄. As the metal fluoride, examples include, but are not limited to, CeF₃ and FeF₃. As the metal phosphate, examples include, but are not limited to, CePO₄, CrPO₄, AlPO₄ and FePO₄. As the macrocyclic metal complex, examples include, but are not limited to, Fe-porphyrin, Co-porphyrin, heme and catalase. As the peroxide decomposition catalyst, one may be selected from these substances and used alone, or two or more substances may be selected from them and used in combination. The peroxide decomposition catalysts may be CeO₂, RuO₂, CePO₄ or the like, because of their high performance of decomposing hydrogen peroxide and hydroxyl radicals.

The peripheral portion of the first gas diffusion layer includes the hydrophilic layer on the first catalyst layer-side surface.

The hydrophilic layer may be disposed to be flush with the first catalyst layer-side surface of the central portion of the first gas diffusion layer. The peripheral portion of the first gas diffusion layer may be the hydrophilic layer.

The hydrophilic layer contains a hydrophilic material. As the hydrophilic material, examples include, but are not limited to, conventionally-known electrolytes. As the electrolyte, examples include those exemplified abode as the electrolyte used in the catalyst layer.

The central portion of the first gas diffusion layer may include the water-repellent layer on the first catalyst layer-side surface.

The water repellent layer may be disposed to be flush with the first catalyst layer-side surface of the peripheral portion of the first gas diffusion layer.

The water repellent layer may be a microporous layer (MPL). The microporous layer may contain a mixture of a water repellent resin such as PTFE and an electroconductive material such as carbon black.

In the first gas diffusion layer, any other portion than the hydrophilic layer may be formed of the water repellent layer.

The electrolyte membrane may be a solid polymer electrolyte membrane. As the solid polymer electrolyte membrane, examples include, but are not limited to, a hydrocarbon electrolyte membrane and a fluorine electrolyte membrane such as a thin, moisture-containing perfluorosulfonic acid membrane. The electrolyte membrane may be a Nafion membrane (manufactured by DuPont Co., Ltd.), for example.

The peripheral portion of the electrolyte membrane includes the adhesive layer on the second catalyst layer-side surface.

The electrolyte membrane is attached to the resin frame via the adhesive layer.

The adhesive layer contains an adhesive.

As the adhesive, a commonly-used, polymer-based adhesive may be employed. As the adhesive, examples include, but are not limited to, silicon resin, epoxy resin, synthetic rubber-based resin, fluoro rubber-based resin, phenolic resin, acrylic resin, polyester resin, and modified alkyd-based resins.

The resin frame is disposed on the outer periphery of the membrane electrode gas diffusion layer assembly and is disposed between the first separator and the second separator.

The resin frame may be attached to the first separator and the second separator via an adhesive. As the adhesive, examples include, but are not limited to, those exemplified above as the adhesive contained in the adhesive layer.

The resin frame may include a frame-shaped core layer and two frame-shaped shell layers disposed on both surfaces of the core layer, that is, a first shell layer and a second shell layer.

Like the core layer, the first shell layer and the second shell layer may be disposed in a frame shape on both surfaces of the core layer.

The core layer may be a structural member which has gas sealing properties and insulating properties. The core layer may be formed of such a material, that the structure is unchanged at the temperature of hot pressing in a fuel cell production process. As the material for the core layer, examples include, but are not limited to, resins such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyethersulfone (PES), polyphenylsulfone (PPSU), liquid crystal polymer (LCP) and epoxy resin. The material for the core layer may be a rubber material such as ethylene propylene diene rubber (EPDM), fluorine-based rubber and silicon-based rubber.

From the viewpoint of ensuring insulating properties, the thickness of the core layer may be 5 μm or more, or it may be 30 μm or more. From the viewpoint of reducing the cell thickness, the thickness of the core layer may be 100 μm or less, or it may be 90 μm or less.

To attach the core layer to the anode-side and cathode-side separators and to ensure sealing properties, the first shell layer and the second shell layer may have the following properties: the first and second shell layers have high adhesion to other substances; they are softened at the temperature of hot pressing; and they have lower viscosity and lower melting point than the core layer. More specifically, the first shell layer and the second shell layer may be thermoplastic resin such as polyester-based resin and modified olefin-based resin, or they may be thermosetting resin such as modified epoxy resin. The first shell layer and the second shell layer may be the same kind of resin as the adhesive layer.

The resin for forming the first shell layer and the resin for forming the second shell layer may be the same kind of resin, or they may be different kinds of resins. By disposing the shell layers on both surfaces of the core layer, it becomes easy to attach the resin frame and the two separators by hot pressing.

From the viewpoint of ensuring adhesion, the thickness of the first and second shell layers may be 5 μm or more, or it may be 30 μm or more. From the viewpoint of reducing the cell thickness, the thickness of the first and second shall layers may be 100 μm or less, or it may be 40 μm or less.

In the resin frame, the first shell layer may be disposed only at a part that is attached to the anode-side separator, and the second shell layer may be disposed only at a part attached to the cathode-side separator. The first shell layer disposed on one surface of the core layer may be attached to the cathode-side separator. The second shell layer disposed on the other surface of the core layer may be bonded to the anode-side separator. The resin frame may be sandwiched by the pair of separators.

One of the first separator and the second separator is the cathode-side separator, and the other is the anode-side separator.

The first separator is the cathode-side separator when the first catalyst layer is the cathode catalyst layer. The first separator is the anode-side separator when the first catalyst layer is the anode catalyst layer.

The second separator is the cathode-side separator when the second catalyst layer is the cathode catalyst layer. The second separator is the anode-side separator when the second catalyst layer is the anode catalyst layer.

The first separator and the second separator are collectively referred to as “separator”. The anode-side separator and the cathode-side separator are collectively referred to as “separator”.

The membrane electrode gas diffusion layer assembly is sandwiched by the first separator and the second separator.

The separator may include supply and discharge holes for allowing the reaction gas and the refrigerant to flow in the stacking direction of the unit fuel cells. As the refrigerant, for example, a mixed solution of ethylene glycol and water may be used to prevent freezing at low temperature.

As the supply hole, examples include, but are not limited to, a fuel gas supply hole, an oxidant gas supply hole, and a refrigerant supply hole.

As the discharge hole, examples include, but are not limited to, a fuel gas discharge hole, an oxidant gas discharge hole, and a refrigerant discharge hole.

The separator may include one or more fuel gas supply holes, one or more oxidant gas supply holes, one or more refrigerant supply holes, one or more fuel gas discharge holes, one or more oxidant gas discharge holes, and one or more refrigerant discharge holes.

The separator may include a reactant gas flow path on a surface in contact with the gas diffusion layer. Also, the separator may include a refrigerant flow path for keeping the temperature of the fuel cell constant on the opposite surface to the surface in contact with the gas diffusion layer.

When the separator is the anode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The anode-side separator may include a fuel gas flow path for allowing the fuel gas to flow from the fuel gas supply hole to the fuel gas discharge hole, on the surface in contact with the anode-side gas diffusion layer. The anode-side separator may include a refrigerant flow path for allowing the refrigerant to from the refrigerant supply hole to the refrigerant discharge hole, on the opposite surface to the surface in contact with the anode-side gas diffusion layer.

When the separator is the cathode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The cathode-side separator may include an oxidant gas flow path for allowing the oxidant gas to flow from the oxidant gas supply hole to the oxidant gas discharge hole, on the surface in contact with the cathode-side gas diffusion layer. The cathode-side separator may include a refrigerant flow path for allowing the refrigerant to flow from the refrigerant supply hole to the refrigerant discharge hole, on the opposite surface to the surface in contact with the cathode-side gas diffusion layer.

The separator may be a gas-impermeable electroconductive member or the like. As the electroconductive member, examples include, but are not limited to, gas-impermeable dense carbon obtained by carbon densification, and a metal plate (such as an iron plate, an aluminum plate and a stainless-steel plate) obtained by press-molding. The separator may function as a collector.

The fuel cell stack may include a manifold such as an inlet manifold communicating between the supply holes and an outlet manifold communicating between the discharge holes.

As the inlet manifold, examples include, but are not limited to, an anode inlet manifold, a cathode inlet manifold and a refrigerant inlet manifold.

As the outlet manifold, examples include, but are not limited to, an anode outlet manifold, a cathode outlet manifold and a refrigerant outlet manifold.

In the disclosed embodiments, the fuel gas and the oxidant gas are collectively referred to as “reaction gas”. The reaction gas supplied to the anode is the fuel gas, and the reaction gas supplied to the cathode is the oxidant gas. The fuel gas is a gas mainly containing hydrogen, and it may be hydrogen. The oxidant gas may be oxygen, air, dry air or the like.

The fuel cell of the disclosed embodiments may be produced by the following method, for example.

First, the first gas diffusion layer including the water repellent layer is prepared.

A hydrophilic material is applied to the peripheral portion of the first gas diffusion layer, thereby forming the hydrophilic layer. The method for applying the hydrophilic material is not particularly limited, and it may be spray coating or the like.

Then, the first gas diffusion layer, the first catalyst layer, the electrolyte membrane, the second catalyst layer, and the second gas diffusion layer are disposed in this order and attached to obtain the membrane electrode gas diffusion layer assembly.

The adhesive layer is formed on the peripheral portion of the electrolyte membrane of the membrane electrode gas diffusion layer assembly.

The membrane electrode gas diffusion layer assembly and the resin frame are attached via the adhesive layer.

The membrane electrode gas diffusion layer assembly is sandwiched by the first separator and the second separator via the resin frame. Accordingly, a unit fuel cell is obtained.

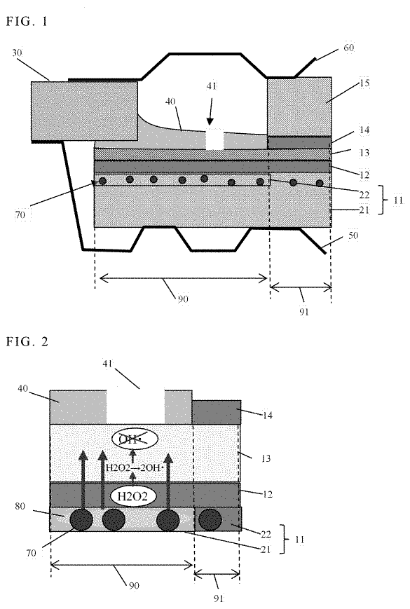

FIG. 1 is a schematic cross-sectional view of an example of the fuel cell of the disclosed embodiments.

The fuel cell shown in FIG. 1 includes a membrane electrode gas diffusion layer assembly, a resin frame 30, a first separator 50, and a second separator 60. The membrane electrode gas diffusion layer assembly includes a first gas diffusion layer 11, a first catalyst layer 12, an electrolyte membrane 13, a second catalyst layer 14, and a second gas diffusion layer 15 in this order.

The resin frame 30 is disposed on the outer periphery of the membrane electrode gas diffusion layer assembly, and the resin frame 30 is disposed between the first separator 50 and the second separator 60.

Each of the first gas diffusion layer 11, the first catalyst layer 12 and the electrolyte membrane 13 includes a peripheral portion 90 which is a region not facing the second catalyst layer 14, and a central portion 91 which is a region being surrounded by the peripheral portion 90 and facing the second catalyst layer 14.

The peripheral portion 90 of the electrolyte membrane 13 includes an adhesive layer 40 on the second catalyst layer-side surface 14.

The adhesive layer 40 includes a crack 41. The adhesive layer 40 may be free of the crack 41.

The electrolyte membrane 13 is attached to the resin frame 30 via the adhesive layer 40.

The first gas diffusion layer 11 contains a peroxide decomposition catalyst 70.

The peripheral portion 90 of the first gas diffusion layer 11 includes a hydrophilic layer 21 on the first catalyst layer 12-side surface.

The central portion 91 of the first gas diffusion layer 11 includes a water repellent layer 22 on the first catalyst layer 12-side surface.

FIG. 2 is a diagram for explaining the mechanism for suppressing deterioration of the electrolyte membrane of the fuel cell according to the disclosed embodiments.

In FIG. 2, the same components as those in FIG. 1 are denoted by the same reference numerals and will not be described below.

In FIG. 2, since the peripheral portion 90 of the first gas diffusion layer 11 includes the hydrophilic layer 21, the hydrophilic layer 21 absorbs liquid water 80 generated by the operation of the fuel cell. As a result, the ionization amount of the peroxide decomposition catalyst 70 increases, and the peroxide decomposition catalyst 70 dissolves in the electrolyte membrane 13, using concentration diffusion as a driving force. As a result, even when the adhesive layer 40 includes the defect portion 41, deterioration of the electrolyte membrane 13 including the corresponding portion is suppressed. In addition, since it is not necessary to incorporate the peroxide decomposition catalyst 70 into the first catalyst layer 12, a decrease in the ionic conductivity of the first catalyst layer 12 is suppressed.

### REFERENCE SIGNS LIST

11: First gas diffusion layer
12: First catalyst layer
13: Electrolyte membrane
14: Second catalyst layer
15: Second gas diffusion layer
21: Water repellent layer
22: Hydrophilic layer
30: Resin frame
40: Adhesive layer
41: Crack
50: First separator
60: Second separator
70: Peroxide decomposition catalyst
80: Liquid water
90: Peripheral portion
91: Central portion

1. A fuel cell comprising a membrane electrode gas diffusion layer assembly, a resin frame, a first separator and a second separator,
wherein the membrane electrode gas diffusion layer assembly includes a first gas diffusion layer, a first catalyst layer, an electrolyte membrane, a second catalyst layer, and a second gas diffusion layer in this order;
wherein the resin frame is disposed on an outer periphery of the membrane electrode gas diffusion layer assembly and is disposed between the first separator and the second separator;
wherein each of the first gas diffusion layer, the first catalyst layer and the electrolyte membrane includes a peripheral portion which is a region not facing the second catalyst layer, and a central portion which is a region being surrounded by the peripheral portion and facing the second catalyst layer;
wherein the peripheral portion of the electrolyte membrane includes an adhesive layer on a second catalyst layer-side surface;
wherein the electrolyte membrane is attached to the resin frame via the adhesive layer;
wherein the first gas diffusion layer contains a peroxide decomposition catalyst; and
wherein the peripheral portion of the first gas diffusion layer includes a hydrophilic layer on a first catalyst layer-side surface.

2. The fuel cell according to claim 1, wherein the central portion of the first gas diffusion layer includes a water repellent layer on a first catalyst layer-side surface.

3. The fuel cell according to claim 1,
wherein the first separator is an anode-side separator;
wherein the first gas diffusion layer is an anode-side gas diffusion layer;
wherein the first catalyst layer is an anode catalyst layer;
wherein the second separator is a cathode-side separator;
wherein the second gas diffusion layer is a cathode-side gas diffusion layer; and
wherein the second catalyst layer is a cathode catalyst layer.
